(19) United States
(12) Patent Application Publication
(10) Pub. No.: US 2022/0362994 A1
(43) Pub. Date: Nov. 17, 2022

(54) COOLING APPARATUS AND METHOD FOR ADDITIVE MANUFACTURE

(71) Applicant: Evolve Additive Solutions, Inc., Minnetonka, MN (US)

(72) Inventor: J. Samuel Batchelder, Somers, NY (US)

(21) Appl. No.: 17/771,696

(22) PCT Filed: Oct. 23, 2020
(86) PCT No.: PCT/US2020/057053

§ 371 Date: Apr. 25, 2022

Related U.S. Application Data
(60) Provisional application No. 62/925,874, filed on Oct. 25, 2019.

(51) Int. Cl. B29C 64/20; B33Y 30/00; G03G 21/20

(52) U.S. Cl. CPC B29C 64/20; B33Y 30/00; G03G 21/206; G03G 15/224

(57) ABSTRACT

A cooling assembly, and method, for an article being printed using a selective toner electrophotographic printing system is disclosed. The assembly includes a surface for delivering and returning cooling gas, the surface containing first plurality of elongate openings in communication with a cooling gas supply; and a second plurality elongate openings in communication with a cooling gas return; wherein the first plurality of elongate openings and second plurality of elongate openings are substantially parallel to one another and alternate with one another.

This application is being filed as a PCT International Patent application on Oct. 23, 2020 in the name of Evolve Additive Solutions, Inc., a U.S. national corporation, applicant for the designation of all countries, and J. Samuel Batchelder, a U.S. Citizen, inventor for the designation of all countries, and claims priority to U.S. Provisional Patent Application No. 62/925,874, filed Oct. 25, 2020, the contents of which are herein incorporated by reference in its entirety.

### FIELD

Embodiments herein relate to apparatuses and methods for cooling of surfaces, in particular embodiments herein relate to apparatuses and methods for cooling of build surfaces during selective toner electrophotographic process (STEP) additive manufacturing.

### BACKGROUND

Additive manufacturing systems are used to build 3D parts from digital representations of the parts using one or more additive manufacturing techniques. Examples of commercially available additive manufacturing techniques include extrusion-based techniques, ink jetting, selective laser sintering, powder/binder jetting, electron beam melting, and stereolithographic processes. For each of these techniques, the digital representation of the 3D part is initially digitally sliced into multiple horizontal layers. For each sliced layer, a tool path is then generated, which provides instructions for the particular additive manufacturing system to form the given layer.

One particularly desirable additive manufacturing method is selective toner electrophotographic process (STEP) additive manufacturing, which allows for rapid, high quality production of 3D parts. STEP manufacturing is performed by applying layers of thermoplastic material that are carried from an electrophotography (EP) engine by a transfer medium (e.g., a rotatable belt or drum). Each layer is transferred to a build platform to print the 3D part (or support structure) in a layer-by-layer manner, where the successive layers are transfused together to produce the 3D part (or support structure). The layers are placed down in an X-Y plane, with successive layers positioned on top of one another in a Z-axis perpendicular to the X-Y plane.

A support structure is sometimes built utilizing the same deposition techniques by which the part material is deposited. The supporting layers or structures are often built underneath overhanging portions or in cavities of parts under construction that are not supported by the part material itself. The part material adheres to the support material during fabrication and the support material is subsequently removable from the completed 3D part when the printing process is complete.

During STEP additive manufacturing heat accumulates in the deposited layers as they build up, and it is necessary to cool the layers of material as they build up into a combination of part and support forming a printed object. Cooling of the printed object is necessary to maintain the shape of the object, avoid undesirable warping and shifting of the layers, allow for further layers to be added, etc. Therefore, a need exists for improved systems and methods for cooling of the build object during STEP additive manufacturing.

### SUMMARY

Embodiments herein relate to apparatuses and methods for cooling of surfaces, in particular material build surfaces during selective toner electrophotographic process (STEP) additive manufacturing. The material build surface can include both part material and support material, or just part or support material at any given layer. The system and methods utilize cooling gases delivered to the top build surface by way of a plurality of elongate, narrow openings formed in a substantially planar surface on the underside of the cooling apparatus. This surface on the underside of the cooling apparatus is positioned above the STEP material build surface, generally in very close proximity to the material build surface. The elongate, narrow openings are typically positioned in an alternating arrangement with a first plurality openings delivering cooling gas while a second plurality of openings remove cooling gas after the gas has passed over the surface being cooled. These first and second plurality of openings alternate with one another such that openings delivering cooling gas generally have adjacent openings that remove cooling gas.

During the STEP additive manufacturing process, the alternating openings generally are positioned very close to the material build surface being cooled. The flow of cooling gas is often such that the cooling gas exiting from each of the first plurality of openings is directed substantially perpendicularly down onto the surface being cooled, and is then bifurcated into two streams that each travel substantially parallel to the top of the build surface toward an adjacent second plurality of return openings and then out through the return openings and out of the cooling apparatus. In certain embodiments the width of the plurality of openings is approximately twice the gap between the underside of the cooling apparatus and the top of the build surface. The length of the plurality of openings is much greater than the width of the openings, and generally corresponds substantially to the dimension of the build platform that travels beneath the cooling assembly.

In an embodiment, a cooling assembly for an article being printed using a selective toner electrophotographic printing system has a substantially planar surface for delivering and returning cooling gas, the surface oriented parallel to the path of travel of the article being printed and containing: a first plurality of elongate openings have a width of less than 2 millimeters, the first plurality of elongate openings in communication with a cooling gas supply; and a second plurality elongate openings have a width of less than 2 millimeters, the second plurality of elongate openings in communication with a cooling gas return; wherein the length and width of the first plurality of elongate openings are substantially the same as the length and width of the second plurality of elongate openings; the first plurality of elongate openings and second plurality of elongate openings are substantially parallel to one another and alternate with one another; and the surface is maintained above the article being printed by a distance of approximately 30 to 70 percent of the width of the first plurality of elongate openings.

In an embodiment, a method of cooling an article being printed using a selective toner electrophotographic printing system, the assembly can include, the method including providing a substantially planar surface for delivering and returning cooling gas, the surface oriented parallel to the path of travel of the article being printed and containing a first plurality of elongate openings having a width of less than 2 millimeters, the first plurality of elongate openings in communication with a cooling gas supply; and a second plurality elongate openings having a width of less than 2 millimeters, the second plurality of elongate openings in communication with a cooling gas return; wherein the length and width of the first plurality of elongate openings are substantially the same as the length and width of the second plurality of elongate openings; the first plurality of elongate openings and second plurality of elongate openings are substantially parallel to one another and alternate with one another; and passing an article being printed beneath the substantially planer surface a distance of approximately 30 to 70 percent of the width of the first plurality of elongate openings.

The cooling assembly of the present disclosure can cool an article being printed much more efficiently than typical cooling assemblies, thereby using much less energy for cooling. In some cases energy savings can be 25 percent, 50 percent, 75 percent or more relative to prior assemblies.

More broadly, in an embodiment, a cooling assembly has a surface for delivering and returning cooling gas, the surface containing a first plurality of elongate openings in communication with a cooling gas supply; and a second plurality elongate openings in communication with a cooling gas return; wherein the first plurality of elongate openings and second plurality of elongate openings are substantially parallel to one another and alternate with one another.

In an embodiment, the surface containing the elongate openings is substantially planar.

In an embodiment, the surface for delivering and returning cooling gas is oriented parallel to the path of travel of the article being printed.

In an embodiment, the surface for delivering and returning cooling gas is oriented above an article during printing of the article.

In an embodiment, the length and width of the first plurality of elongate openings are substantially the same as the length and width of the second plurality of elongate openings.

In an embodiment, the surface containing the first plurality of elongate openings and second plurality of elongate openings are configured to be positioned parallel to the surface of a build platform in the STEP system.

In an embodiment, the first plurality of elongate openings and second plurality of elongate openings are arranged such that the longest dimension of the openings is arranged perpendicular to the direction of travel of a build platform through the cooling assembly.

In an embodiment, the surface containing the plurality of openings is maintained above an article being printed by a distance of approximately 45 to 55 percent of the width of the first plurality of elongate openings.

In an embodiment, the surface containing the plurality of openings is maintained above the article being printed by a distance of approximately 40 to 60 percent of the width of the first plurality of elongate openings.

In an embodiment, the surface containing the plurality of openings is maintained above the article being printed by a distance of approximately 30 to 70 percent of the width of the first plurality of elongate openings.

In an embodiment, the surface containing the plurality of openings is maintained above the article being printed by a distance of less than 5 millimeters above an article being printed.

In an embodiment, the surface containing the plurality of openings is maintained above the article being printed by a distance of less than 4 millimeters above an article being printed.

In an embodiment, the surface containing the plurality of openings is maintained above the article being printed by a distance of less than 3 millimeters above an article being printed.

In an embodiment, the surface containing the plurality of openings is maintained above the article being printed by a distance of less than 2 millimeters above an article being printed.

In an embodiment, the surface containing the plurality of openings is maintained above the article being printed by a distance of less than 1 millimeters above an article being printed.

In an embodiment, the surface containing the plurality of openings is maintained above the article being printed by a distance of 1 to 2 millimeters above an article being printed.

In an embodiment, the surface containing the plurality of openings is maintained above the article being printed by a distance of 1 to 3 millimeters above an article being printed.

In an embodiment, the first and second plurality of openings have a width of less than 3 millimeters.

In an embodiment, the first and second plurality of openings have a width of less than 2 millimeters.

In an embodiment, the first and second plurality of openings have a width of less than 1 millimeter.

In an embodiment, the first and second plurality of openings have a length of at least 10 centimeters.

In an embodiment, the first and second plurality of openings have a length of at least 20 centimeters.

In an embodiment, the first and second plurality of openings have a length of at least 30 centimeters.

In an embodiment, the first and second plurality of openings have a length at least 50 times the width of the first and second plurality of openings.

In an embodiment, the first and second plurality of openings have a length at least 100 times the width of the first and second plurality of openings.

In an embodiment, the first and second plurality of openings have a length from 100 to 500 times the width of the first and second plurality of openings.

In an embodiment, the first and second plurality of openings are spaced from one another by less than 30 millimeters.

In an embodiment, the first and second plurality of openings are spaced from one another by less than 20 millimeters.

In an embodiment, the first and second plurality of openings are spaced from one another by a distance of approximately 2 to 30 times the width of the plurality of openings.

In an embodiment, the first and second plurality of openings are spaced from one another by a distance of approximately 5 to 20 times the width of the plurality of openings.

In an embodiment, the first and second plurality of openings are spaced from one another by a distance of approximately 10 to 20 times the width of the plurality of openings.

In an embodiment, the cooling gas is air; while in other embodiments the cooling gas is nitrogen gas.

In an embodiment, the cooling gas flowing from the first plurality of openings to the second plurality of openings has a Reynolds number of less than 10,000.

In an embodiment, the cooling gas flowing from the first plurality of openings to the second plurality of openings has a Reynolds number of 6,000 to 8,000

In an embodiment, the apparatus further includes an interdigitated manifold, the interdigitated manifold directing cooling gas to the first plurality of elongate openings and away from the second plurality of elongate openings.

In an embodiment, the openings are arranged such that their longest dimension is oriented substantially perpendicular to the direction of travel of parts beneath the cooling assembly.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a side view of an example STEP additive manufacturing system in accordance with various embodiments herein.

FIG. 2 is a perspective view of an example cooling assembly in accordance with various embodiments herein.

FIG. 3 is a top perspective view of a manifold from a cooling assembly of a STEP additive manufacturing system in accordance with various embodiments herein.

FIG. 4 is a bottom perspective view of the bottom plate of a STEP additive manufacturing system cooling assembly in accordance with various embodiments herein.

FIG. 5 is a side cross sectional view of the bottom plate of a STEP additive manufacturing system cooling assembly of FIG. 4 in accordance with various embodiments herein.

FIG. 6 is a closeup view of of the bottom plate of the STEP additive manufacturing system cooling assembly of FIG. 5 in accordance with various embodiments herein.

FIG. 7 is a closeup schematic side cross sectional view of bottom plate of a STEP additive manufacturing system cooling assembly shown along with material deposited during a STEP manufacturing process in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Embodiments of the present disclosure relate to a selective deposition-based additive manufacturing system, such as an electrostatography-based additive manufacturing system, to print 3D parts and/or support structures with high resolution and smooth surfaces. During the additive manufacturing (also called printing) operation, electrostatographic engines develop or otherwise image each layer of the part and support materials using an electrostatographic process. The developed layers are then transferred to a layer transfusion assembly where they are transfused (e.g., using heat and/or pressure over time) to print one or more 3D parts and support structures in a layer-by-layer manner.

In an embodiment, a cooling assembly for an article being printed using a selective toner electrophotographic printing system has a substantially planar surface for delivering and returning cooling gas, the surface oriented parallel to the path of travel of the article being printed and containing: a first plurality of elongate openings have a width of less than 2 millimeters, the first plurality of elongate openings in communication with a cooling gas supply; and a second plurality elongate openings have a width of less than 2 millimeters, the second plurality of elongate openings in communication with a cooling gas return; wherein the length and width of the first plurality of elongate openings are substantially the same as the length and width of the second plurality of elongate openings; the first plurality of elongate openings and second plurality of elongate openings are substantially parallel to one another and alternate with one another; and the surface is maintained above the article being printed by a distance of approximately 30 to 70 percent of the width of the first plurality of elongate openings.

In an embodiment, a method of cooling an article being printed using a selective toner electrophotographic printing system, the assembly can include, the method including providing a substantially planar surface for delivering and returning cooling gas, the surface oriented parallel to the path of travel of the article being printed and containing a first plurality of elongate openings having a width of less than 2 millimeters, the first plurality of elongate openings in communication with a cooling gas supply; and a second plurality elongate openings having a width of less than 2 millimeters, the second plurality of elongate openings in communication with a cooling gas return; wherein the length and width of the first plurality of elongate openings are substantially the same as the length and width of the second plurality of elongate openings; the first plurality of elongate openings and second plurality of elongate openings are substantially parallel to one another and alternate with one another; and passing an article being printed beneath the substantially planer surface a distance of approximately 30 to 70 percent of the width of the first plurality of elongate openings.

More broadly, in an embodiment, a cooling assembly has a surface for delivering and returning cooling gas, the surface containing a first plurality of elongate openings in communication with a cooling gas supply; and a second plurality elongate openings in communication with a cooling gas return; wherein the first plurality of elongate openings and second plurality of elongate openings are substantially parallel to one another and alternate with one another.

In an embodiment, the surface containing the elongate openings is substantially planar. In an embodiment, the surface for delivering and returning cooling gas is oriented parallel to the path of travel of the article being printed. In an embodiment, the surface for delivering and returning cooling gas is oriented above an article during printing of the article. in an embodiment, the length and width of the first plurality of elongate openings are substantially the same as the length and width of the second plurality of elongate openings. In an embodiment, the surface containing the first plurality of elongate openings and second plurality of elongate openings are configured to be positioned parallel to the surface of a build platform in the STEP system.

In an embodiment, the first plurality of elongate openings and second plurality of elongate openings are arranged such that the longest dimension of the openings is arranged perpendicular to the direction of travel of a build platform through the cooling assembly.

In an embodiment, the surface containing the plurality of openings is maintained above an article being printed by a distance of approximately 45 to 55 percent of the width of the first plurality of elongate openings. In an embodiment, the surface containing the plurality of openings is maintained above the article being printed by a distance of approximately 40 to 60 percent of the width of the first plurality of elongate openings. In an embodiment, the surface containing the plurality of openings is maintained above the article being printed by a distance of approximately 30 to 70 percent of the width of the first plurality of elongate openings. In an embodiment, the surface containing the plurality of openings is maintained above the article being printed by a distance of less than 5 millimeters above an article being printed.

In an embodiment, the surface containing the plurality of openings is maintained above the article being printed by a distance of less than 4 millimeters above an article being printed. In an embodiment, the surface containing the plurality of openings is maintained above the article being printed by a distance of less than 3 millimeters above an article being printed. In an embodiment, the surface containing the plurality of openings is maintained above the article being printed by a distance of less than 2 millimeters above an article being printed. In an embodiment, the surface containing the plurality of openings is maintained above the article being printed by a distance of less than 1 millimeters above an article being printed. In an embodiment, the surface containing the plurality of openings is maintained above the article being printed by a distance of 1 to 2 millimeters above an article being printed. In an embodiment, the surface containing the plurality of openings is maintained above the article being printed by a distance of 1 to 3 millimeters above an article being printed.

In an embodiment, the first and second plurality of openings have a width of less than 3 millimeters. In an embodiment, the first and second plurality of openings have a width of less than 2 millimeters. In an embodiment, the first and second plurality of openings have a width of less than 1 millimeter.

In an embodiment, the first and second plurality of openings have a length of at least 10 centimeters. In an embodiment, the first and second plurality of openings have a length of at least 20 centimeters. In an embodiment, the first and second plurality of openings have a length of at least 30 centimeters. In an embodiment, the first and second plurality of openings have a length at least 50 times the width of the first and second plurality of openings. In an embodiment, the first and second plurality of openings have a length at least 100 times the width of the first and second plurality of openings. In an embodiment, the first and second plurality of openings have a length from 100 to 500 times the width of the first and second plurality of openings. In an embodiment, the first and second plurality of openings are spaced from one another by less than 30 millimeters. In an embodiment, the first and second plurality of openings are spaced from one another by less than 20 millimeters.

In an embodiment, the first and second plurality of openings are spaced from one another by a distance of approximately 2 to 30 times the width of the plurality of openings. In an embodiment, the first and second plurality of openings are spaced from one another by a distance of approximately 5 to 20 times the width of the plurality of openings. In an embodiment, the first and second plurality of openings are spaced from one another by a distance of approximately 10 to 20 times the width of the plurality of openings.

In an embodiment, the cooling gas is air; while in other embodiments the cooling gas is nitrogen gas.

In an embodiment, the cooling gas flowing from the first plurality of openings to the second plurality of openings has a Reynolds number of less than 10,000. In an embodiment, the cooling gas flowing from the first plurality of openings to the second plurality of openings has a Reynolds number of 6,000 to 8,000. In an embodiment, the apparatus further includes an interdigitated manifold, the interdigitated manifold directing cooling gas to the first plurality of elongate openings

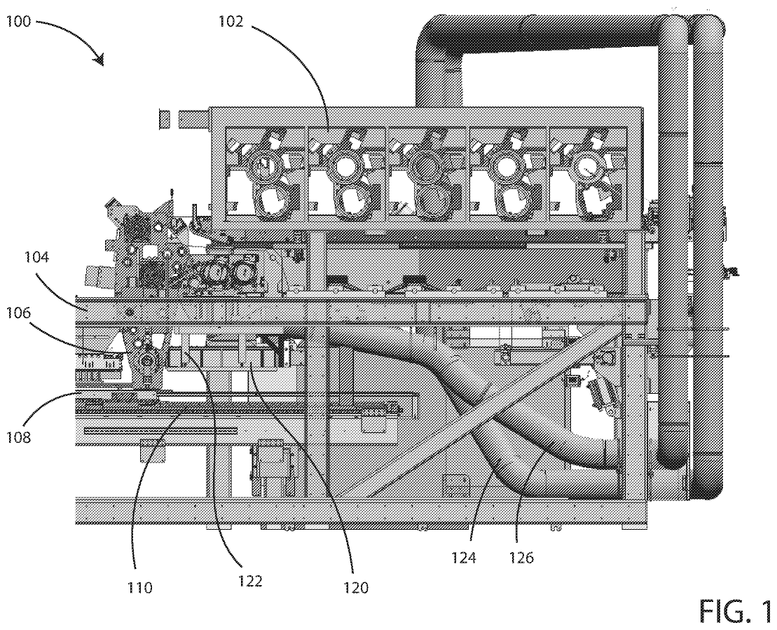

FIG. 1 is a simplified diagram of an exemplary electrophotography-based additive manufacturing system 100 configured to perform a selective deposition process to printing 3D parts and associated support structures, in accordance with embodiments of the present disclosure. As shown in FIG. 1, additive manufacturing system 100 includes one or more EP engines, generally referred to as 102, a support structure 104, a transfusion assembly 106, a build platform 108, a build platform track 110, a cooling assembly 120 including mounting frame 122, and a cooling gas supply 124 and cooling gas return 126. Examples of suitable components and functional operations for system 10 include those disclosed in Hanson et al., U.S. Pat. Nos. 8,879,957 and 8,488,994, and in Comb et al., U.S. Patent Publication Nos. 2013/0186549 and 2013/0186558.

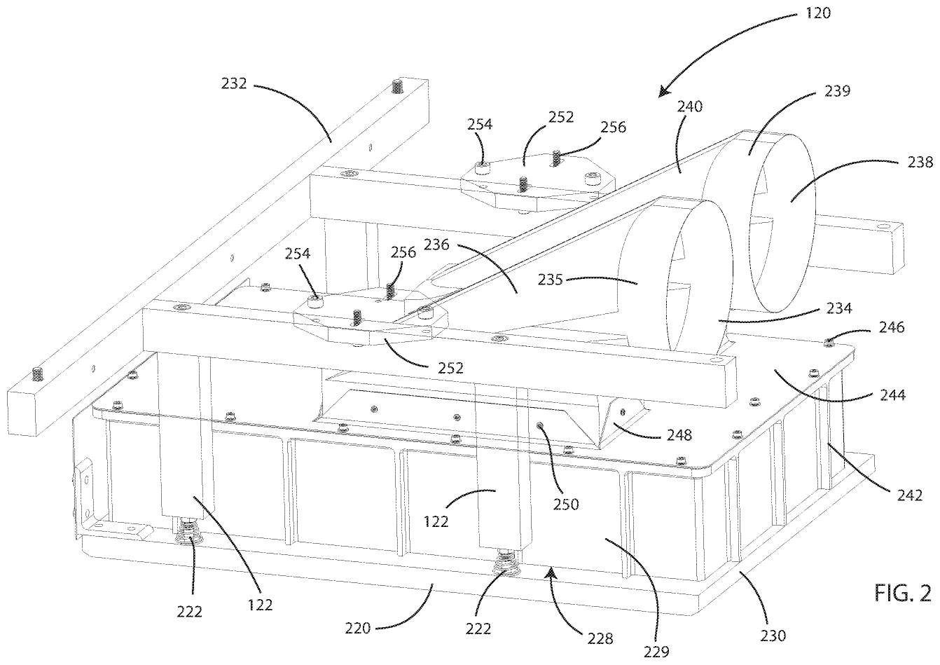

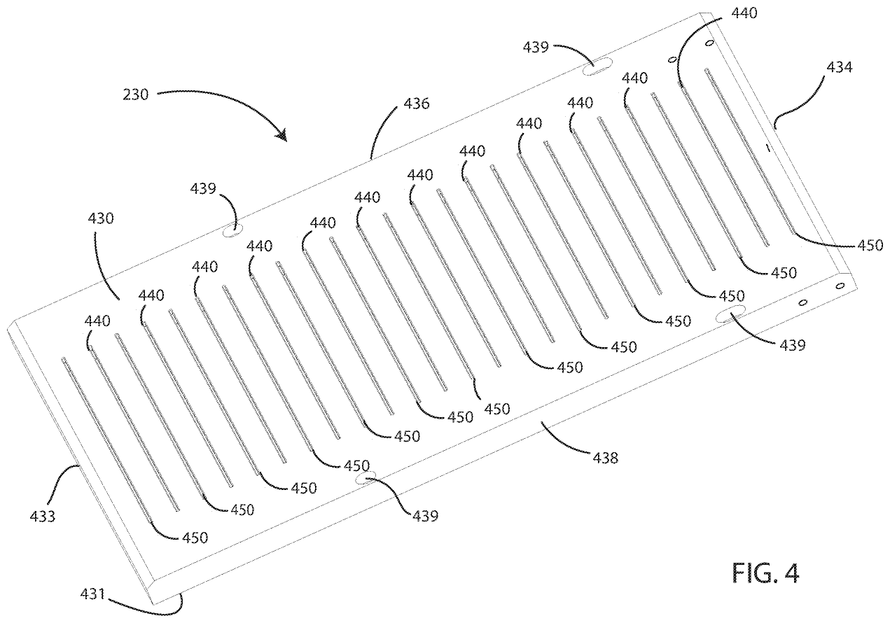

Referring now to FIG. 2, a perspective view of the example cooling assembly 120 in accordance with various embodiments herein is shown. The cooling assembly 120 includes a manifold 228 to which a bottom plate 230 is secured. The manifold 228 and bottom plate 230 are constructed such that a build platform can travel beneath the manifold 228 and bottom plate 230 so as to cool layers of material building up upon the build platform. The bottom plate 230 includes a plurality of openings (shown in FIGS. 4 to 7). The manifold 228 includes side walls 229, which are optionally reinforced with support members 242. Bottom plate 230 includes a first side 220. The top of the manifold 228 includes a cover 244 secured to the manifold 228 by, for example, fasteners 246. The cover 244 includes ducting for connection to the cooling gas supply 124 and cooling gas return 126. In the cooling assembly 120 of FIG. 2, a first duct 235 includes an opening 234 leading to a funnel portion 236 feeding into a manifold 228; along with a second duct 239 with duct 238 leading to a funnel portion 240. Either the first duct 235 or second duct 239 can lead to the cooling gas supply 124 and cooling gas return 126 (of FIG. 1), with the other of the first duct 235 and second duct 239 being connect to the remaining of the cooling gas supply 124 and cooling gas return 126. The first duct 235 and second duct 239 are connected to openings in the cover 244, and are secured by way of flaps 248 with fasteners 250 in the depicted embodiment. It will be appreciated that various alternative securing options are available.

In addition, mounting frame 122 is shown in FIG. 2, and mounting frame 122 is an example of a structure for securing the cooling assembly 120 to the support structure 104. Alternative mounting assemblies are also possible. In this example the mounting frame 122 including a spring mounts 222 at the interface to the bottom plate 230. The spring mount 222 allows for upward movement of the bottom plate 230 (and thereby the manifold 228) when pushed from below (such as if the bottom plate is unintentionally bumped from below during manufacturing). The mounting frame 122 further includes horizontal top members 232 that are secured by means of mounting brackets 252, to the support structure 104 (FIG. 1), including cooling assembly mounting fasteners 254 and frame mounting fasteners 256. Various alternative or additional mounting construction can be used. It is often desirable that the mounting construction allows for adjusting of the position of the cooling assembly, in particular for adjusting of the precise location and orientation of the bottom plate 230.

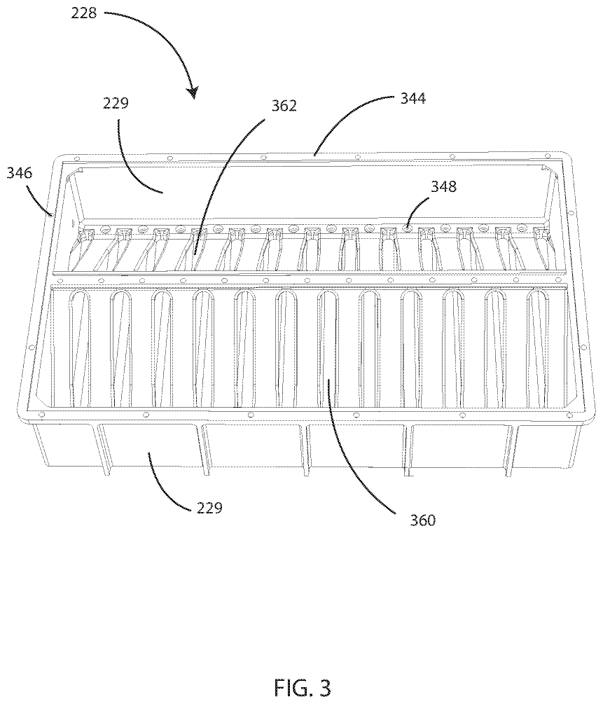

FIG. 3 is a top perspective view of an example manifold 228 from a cooling assembly in accordance with various embodiments herein. The manifold 228 includes side walls 229; along with a top flange 344 and mounting holes 346 for securing the cover 244 (shown in FIG. 2) to the top of the manifold. The manifold 228 includes a plurality of a first set of flow channels 360 and second set of flow channels 362. These flow channels are in communication with elongate openings in the bottom plate 230. The manifold 228 also includes a plurality of holes 348 for securing to bottom plate 230.

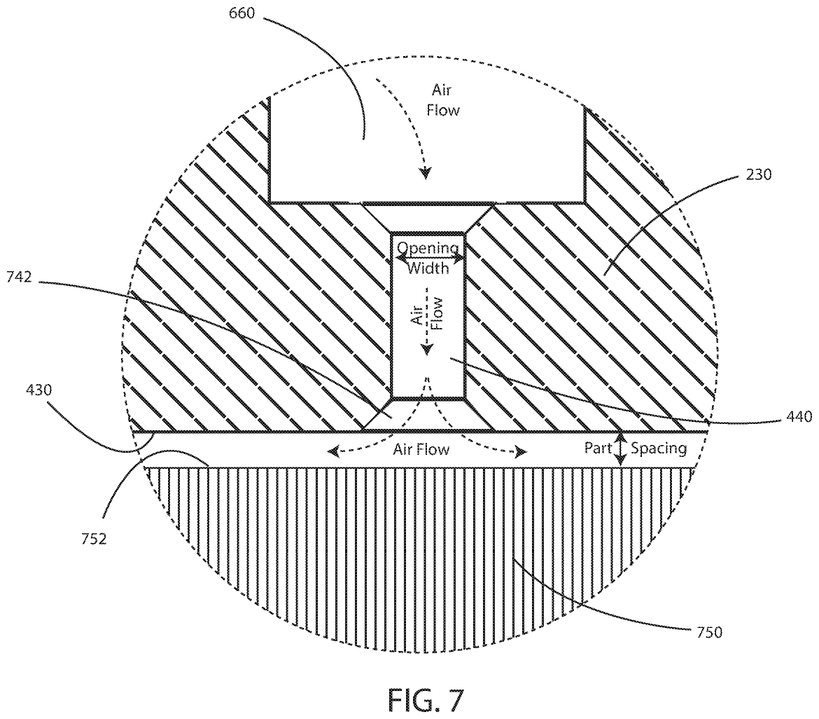

FIG. 4 is a bottom perspective view of the bottom plate 230 of a cooling assembly 120 in accordance with various embodiments herein. The bottom plate 230 includes a first set of first openings 440 and a second set of second openings 450. These first openings 440 and second openings 450 are each, respectively, in communication with the first set of flow channels 360 and second set of flow channels 362 as shown in FIG. 3. Thus, the overall construction is that (for example) the cooling gas flow path is from a cooling gas supply 126 into the first duct 235, then through the first set of flow channels 360 in the manifold 228, out through the first openings 440 and along the surface of a build part (shown below in FIG. 7), back into the second openings 450, thereafter through the flow channels 362 of the manifold 228 and out through the duct 238 to the cooling gas return 126. In the alternative the cooling gas can flow in the opposite direction. It will also be appreciated that there can be gas losses along the way, such as by leaks, and that not all of the cooling gas that leaves the first openings 440 will return to the second openings 450. However, typically the great majority of the gas that flows out the first openings 440 will flow back into the second openings 450.

Mounting holes 439 in the bottom plate 230 are also shown, the mounting holes 439 can be secured at the spring mounts 222 (of FIG. 2). Bottom plate 230 further includes first end 433 and second end 434, along with first side 436 and second side 438. The elongate opening generally extend lengthwise from the first side 436 to the second side 438, and are aligned in alternating parallel rows from the first end 433 to the second end 434. Generally, there is an equal, or nearly equal, number of first openings 440 and second openings 450. Further, the length of each of first openings 440 and second openings 450 (measured in the direction from the first side 436 to the second side 438) is sufficient to fully cover a part being manufactured as it passes beneath the bottom plate 230. Thus, in use a part being manufactured will travel along the bottom plate 230 from one end to another, coming in contact with all of the first openings 440 and second openings 450.

In an embodiment, the first openings 440 and second openings 450 have a width of less than 2 millimeters. In an embodiment, the first and second plurality of openings have a width of less than 1.5 millimeters, or less than 1 millimeter. In an embodiment, the first and second plurality of openings have a length of at least 10 centimeters. In an embodiment, the first and second plurality of openings have a length of at least 20 centimeters. In an embodiment, the first and second plurality of openings have a length of at least 30 centimeters.

In an embodiment, the first and second plurality of openings have a length at least 50 times the width of the first and second plurality of openings. In an embodiment, the first and second plurality of openings have a length at least 100 times the width of the first and second plurality of openings. In an embodiment, the first and second plurality of openings have a length from 100 to 500 times the width of the first and second plurality of openings.

In an embodiment, the first and second plurality of openings are spaced from one another by less than 30 millimeters. In an embodiment, the first and second plurality of openings are spaced from one another by less than 20 millimeters. In an embodiment, the first and second plurality of openings are spaced from one another by a distance of approximately 2 to 30 times the width of the plurality of openings. In an embodiment, the first and second plurality of openings are spaced from one another by a distance of approximately 5 to 20 times the width of the plurality of openings. In an embodiment, the first and second plurality of openings are spaced from one another by a distance of approximately 10 to 20 times the width of the plurality of openings.

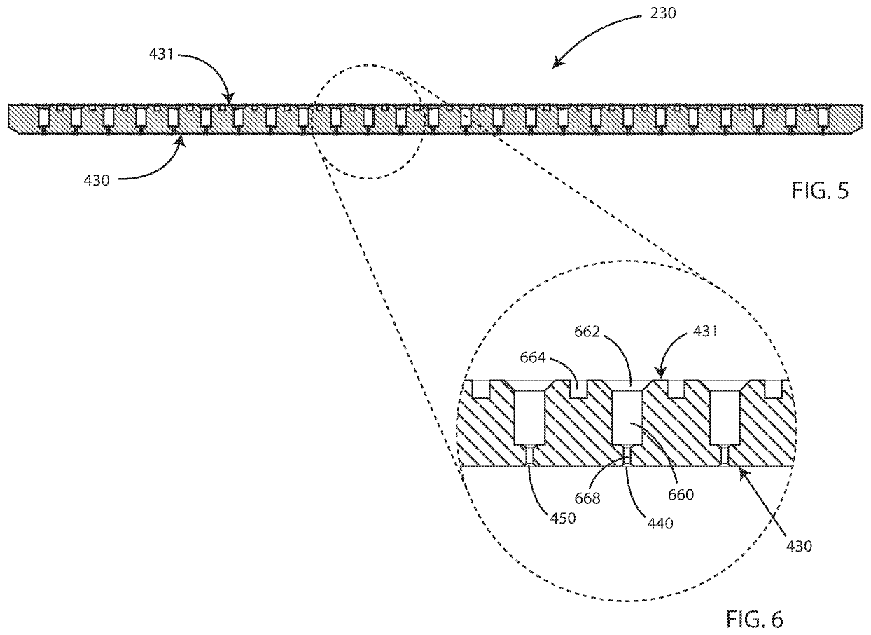

FIG. 5 is a side cross sectional view of the bottom plate 230 of a cooling assembly 120 of FIG. 4 in accordance with various embodiments. The bottom plate 230 includes a top surface 431 and a bottom surface 430. The top surface 431 is secured to the bottom of a manifold 228 (see FIG. 2 and FIG. 3) such that the top surface 431 is exposed to the interior of manifold 228. The bottom surface 430 is positioned to form the underside of the cooling assembly 120 and is positioned above a part being printed using a STEP process.

FIG. 6 is a closeup view of the bottom plate of the cooling assembly of FIG. 5. The bottom plate 230 includes the plurality of openings from which cooling gas will flow out and return. The first openings 440 and second openings 450 are shown. Various shapes and sizes for these first openings 440 and second openings 450 are possible, but generally they are elongate openings (when measured from above) that are designed to deliver and return cooling gas with low resistance. In this embodiment the cross section of the openings shows that the first openings 440 and second openings 450 include an upper region 662 with a slightly tapered cross section that leads to an intermediate region 660 and then into a narrower lower region 668. FIG. 6 also shows optional recesses 664 for receiving and aligning with portions of the manifold. As used herein, the opening width of the of the first openings 440 and second openings 450 refers to the width of the narrower lower region 668.

FIG. 7 is a closeup schematic side cross sectional view of bottom plate 230 of a cooling assembly 120 shown along with material deposited during a STEP manufacturing process in accordance with various embodiments herein. The bottom surface 430 of the bottom plate 230 is shown, along with build material 750 (such as part material, support material, or both). The build material 750 includes a top surface 752. The bottom surface 430 is separated from the top surface 752 of the build material 750 by a part spacing distance. The first opening shown here in FIG. 7 also includes an “opening width”; and also optionally shows an exit region 742 that is slightly wider than the opening width of the narrower lower region 668 (see FIG. 6). In the depicted construction to flow of a cooling gas (such as air) is from top to bottom in this design, and then out through the first openings 440 to the gap (as measured by part spacing) between the bottom surface 430 and top surface 752 of the part. The air flow generally bifurcates and flows left and right (in this figure) and then to an adjacent second opening (not shown).

In an embodiment, the bottom surface 430 is maintained above an article being printed by a part spacing distance of approximately 45 to 55 percent of the opening width of the first plurality of elongate openings. In an embodiment, the bottom surface 430 is maintained above the article being printed by a distance of approximately 40 to 60 percent of the width of the first plurality of elongate openings. In an embodiment, the bottom surface 430 is maintained above the article being printed by a distance of approximately 30 to 70 percent of the width of the first plurality of elongate openings. In an embodiment, the bottom surface 430 is maintained above the article being printed by a distance of less than 5 millimeters above an article being printed. In an embodiment, the bottom surface 430 is maintained above the article being printed by a distance of less than 4 millimeters above an article being printed. In an embodiment, the bottom surface 430 is maintained above the article being printed by a distance of less than 3 millimeters above an article being printed.

In an embodiment, the bottom surface 430 is maintained above the top surface 752 of the build material 750 being printed by a distance of less than 2 millimeters. In an embodiment, the bottom surface 430 is maintained above the article being printed by a distance of less than 1 millimeters above an article being printed. In an embodiment, the bottom surface 430 is maintained above the article being printed by a distance of 1 to 2 millimeters above an article being printed. In an embodiment, the bottom surface 430 is maintained above the article being printed by a distance of 1 to 3 millimeters above an article being printed. In an embodiment, the first and second plurality of openings have a width of less than 3 millimeters.

The terms “at least one” and “one or more of” an element are used interchangeably, and have the same meaning that includes a single element and a plurality of the elements, and may also be represented by the suffix “(s)” at the end of the element.

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis.

The terms “about” and “substantially” are used herein with respect to measurable values and ranges due to expected variations known to those skilled in the art (e.g., limitations and variabilities in measurements).

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability.

The term “selective deposition” refers to an additive manufacturing technique where one or more layers of particles are fused to previously deposited layers utilizing heat and pressure over time where the particles fuse together to form a layer of the part and also fuse to the previously printed layer.

The term “electrostatography” refers to the formation and utilization of latent electrostatic charge patterns to form an image of a layer of a part, a support structure or both on a surface. Electrostatography includes, but is not limited to, electrophotography where optical energy is used to form the latent image, ionography where ions are used to form the latent image and/or electron beam imaging where electrons are used to form the latent image.

Unless otherwise specified, pressures referred to herein are based on atmospheric pressure (i.e. one atmosphere).

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A cooling assembly for an article being printed using a selective toner electrophotographic printing system, the cooling assembly comprising:
a surface for delivering and returning cooling gas, the surface containing:
a first plurality of elongate openings in communication with a cooling gas supply; and
a second plurality elongate openings in communication with a cooling gas return;
wherein the first plurality of elongate openings and second plurality of elongate openings are substantially parallel to one another and alternate with one another.

2. The cooling assembly of any of claims 1 and 3-38, wherein the surface containing the elongate openings is substantially planar.

3. The cooling assembly of any of claims 1-2 and 4-38, wherein the surface for delivering and returning cooling gas is oriented parallel to a path of travel of the article being printed.

4. The cooling assembly of any of claims 1-3 and 5-38, wherein the surface for delivering and returning cooling gas is oriented above an article during printing of the article.

5. The cooling assembly of any of claims 1-4 and 6-38, wherein the length and width of the first plurality of elongate openings are substantially the same as the length and width of the second plurality of elongate openings.

6. The cooling assembly of any of claims 1-5 and 7-38, wherein the surface containing the first plurality of elongate openings and second plurality of elongate openings are configured to be positioned parallel to the surface of a build platform in the selective toner electrophotographic printing system.

7. The cooling assembly of any of claims 1-6 and 8-38, wherein the first plurality of elongate openings and second plurality of elongate openings are arranged such that the longest dimension of the openings is positioned perpendicular to the direction of travel of a build platform through the cooling assembly.

8. The cooling assembly of any of claims 1-7 and 9-38, further comprising an interdigitated manifold.

9. The cooling assembly of any of claims 1-8 and 10-38, wherein the surface is maintained above an article being printed by a distance of approximately 45 to 55 percent of the width of the first plurality of elongate openings.

10. The cooling assembly of any of claims 1-9 and 11-38, wherein the surface is maintained above the article being printed by a distance of approximately 40 to 60 percent of the width of the first plurality of elongate openings.

11. The cooling assembly of any of claims 1-10 and 12-38, wherein the surface is maintained above the article being printed by a distance of approximately 30 to 70 percent of the width of the first plurality of elongate openings.

12. The cooling assembly of any of claims 1-11 and 13-38, wherein the surface is maintained above the article being printed by a distance of less than 5 millimeters above an article being printed.

13. The cooling assembly of any of claims 1-12 and 14-38, wherein the surface is maintained above the article being printed by a distance of less than 4 millimeters above an article being printed.

14. The cooling assembly of any of claims 1-13 and 15-38, wherein the surface is maintained above the article being printed by a distance of less than 3 millimeters above an article being printed.

15. The cooling assembly of any of claims 1-14 and 16-38, wherein the surface is maintained above the article being printed by a distance of less than 2 millimeters above an article being printed.

16. The cooling assembly of any of claims 1-15 and 17-38, wherein the surface is maintained above the article being printed by a distance of less than 1 millimeters above an article being printed.

17. The cooling assembly of any of claims 1-16 and 18-38, wherein the surface is maintained above the article being printed by a distance of 1 to 2 millimeters above an article being printed.

18. The cooling assembly of any of claims 1-17 and 19-38, wherein the surface is maintained above the article being printed by a distance of 1 to 3 millimeters above an article being printed.

19. The cooling assembly of any of claims 1-18 and 20-38, wherein the first and second plurality of openings have a width of less than 3 millimeters.

20. The cooling assembly of any of claims 1-19 and 21-38, wherein the first and second plurality of openings have a width of less than 2 millimeters.

21. The cooling assembly of any of claims 1-20 and 22-38, wherein the first and second plurality of openings have a width of less than 1 millimeter.

22. The cooling assembly of any of claims 1-21 and 23-38, wherein the first and second plurality of openings have a length of at least 10 centimeters.

23. The cooling assembly of any of claims 1-22 and 24-38, wherein the first and second plurality of openings have a length of at least 20 centimeters.

24. The cooling assembly of any of claims 1-23 and 25-38, wherein the first and second plurality of openings have a length of at least 30 centimeters.

25. The cooling assembly of any of claims 1-24 and 26-38, wherein the first and second plurality of openings have a length at least 50 times the width of the first and second plurality of openings.

26. The cooling assembly of any of claims 1-25 and 27-38, wherein the first and second plurality of openings have a length at least 100 times the width of the first and second plurality of openings.

27. The cooling assembly of any of claims 1-26 and 28-38, wherein the first and second plurality of openings have a length from 100 to 500 times the width of the first and second plurality of openings.

28. The cooling assembly of any of claims 1-27 and 29-38, wherein the first and second plurality of openings are spaced from one another by less than 30 millimeters.

29. The cooling assembly of any of claims 1-28 and 30-38, wherein the first and second plurality of openings are spaced from one another by less than 20 millimeters.

30. The cooling assembly of any of claims 1-29 and 31-38, wherein the first and second plurality of openings are spaced from one another by a distance of approximately 2 to 30 times the width of the plurality of openings.

31. The cooling assembly of any of claims 1-30 and 32-38, wherein the first and second plurality of openings are spaced from one another by a distance of approximately 5 to 20 times the width of the plurality of openings.

32. The cooling assembly of any of claims 1-31 and 33-38, wherein the first and second plurality of openings are spaced from one another by a distance of approximately 10 to 20 times the width of the plurality of openings.

33. The cooling assembly of any of claims 1-32 and 34-38, wherein the cooling gas is air.

34. The cooling assembly of any of claims 1-33 and 35-38, wherein the cooling gas is nitrogen gas.

35. The cooling assembly of any of claims 1-34 and 36-38, wherein the cooling gas flowing from the first plurality of openings to the second plurality of openings has a Reynolds number of less than 10,000.

36. The cooling assembly of any of claims 1-35 and 37-38, wherein the cooling gas flowing from the first plurality of openings to the second plurality of openings has a Reynolds number of 6,000 to 8,000.

37. The cooling assembly of any of claims 1-36 and 38, further comprising an interdigitated manifold, the interdigitated manifold directing cooling gas to the first plurality of elongate openings and away from the second plurality of elongate openings.

38. The cooling assembly of any of claims 1-37, wherein the slots are arranged such that their long dimension is oriented substantially perpendicular to the direction of travel of parts beneath the cooling assembly.

39. A cooling assembly for an article being printed using a selective toner electrophotographic printing system, the assembly comprising:
a substantially planar surface for delivering and returning cooling gas, the surface oriented parallel to the path of travel of the article being printed and containing:
a first plurality of elongate openings having a width of less than 2 millimeters, the first plurality of elongate openings in communication with a cooling gas supply.; and
a second plurality elongate openings having a width of less than 2 millimeters, the second plurality of elongate openings in communication with a cooling gas return;
wherein the length and width of the first plurality of elongate openings are substantially the same as the length and width of the second plurality of elongate openings;
the first plurality of elongate openings and second plurality of elongate openings are substantially parallel to one another and alternate with one another; and
the surface is maintained above the article being printed by a distance of approximately 30 to 70 percent of the width of the first plurality of elongate openings.

40. The cooling assembly of any of claims 39 and 41-59, wherein the surface for delivering and returning cooling gas is oriented above an article during printing of the article.

41. The cooling assembly of any of claims 39-40 and 42-59, wherein the surface containing the first plurality of elongate openings and second plurality of elongate openings are configured to be positioned parallel to a build platform in the selective toner electrophotographic printing system.

42. The cooling assembly of any of claims 39-41 and 43-59, further comprising an interdigitated manifold.

43. The cooling assembly of any of claims 39-42 and 44-59, wherein the surface is maintained above the article being printed by a distance of approximately 45 to 55 percent of the width of the first plurality of elongate openings.

44. The cooling assembly of any of claims 39-43 and 45-59, wherein the surface is maintained above the article being printed by a distance of approximately 40 to 60 percent of the width of the first plurality of elongate openings.

45. The cooling assembly of any of claims 39-44 and 46-59, wherein the surface is maintained above the article being printed by a distance of less than 2 millimeters above an article being printed.

46. The cooling assembly of any of claims 39-45 and 47-59, wherein the surface is maintained above the article being printed by a distance of less than 1 millimeters above an article being printed.

47. The cooling assembly of any of claims 39-46 and 48-59, wherein the first and second plurality of openings have a width of less than 3 millimeters.

48. The cooling assembly of any of claims 39-47 and 49-59, wherein the first and second plurality of openings have a width of less than 1 millimeter.

49. The cooling assembly of any of claims 39-48 and 50-59, wherein the first and second plurality of openings are spaced from one another by less than 30 millimeters.

50. The cooling assembly of any of claims 39-49 and 51-59, wherein the first and second plurality of openings are spaced from one another by less than 20 millimeters.

51. The cooling assembly of any of claims 39-50 and 52-59, wherein the first and second plurality of openings are spaced from one another by a distance of approximately 2 to 30 times the width of the plurality of openings.

52. The cooling assembly of any of claims 39-51 and 53-59, wherein the first and second plurality of openings are spaced from one another by a distance of approximately 5 to 20 times the width of the plurality of openings.

53. The cooling assembly of any of claims 39-52 and 54-59, wherein the first and second plurality of openings are spaced from one another by a distance of approximately 10 to 20 times the width of the plurality of openings.

54. The cooling assembly of any of claims 39-53 and 55-59, wherein the cooling gas is air.

55. The cooling assembly of any of claims 39-54 and 56-59, wherein the cooling gas is nitrogen gas.

56. The cooling assembly of any of claims 39-55 and 57-59, wherein the cooling gas flowing from the first plurality of openings to the second plurality of openings has a Reynolds number of less than 10,000.

57. The cooling assembly of any of claims 39-56 and 58-59, wherein the cooling gas flowing from the first plurality of openings to the second plurality of openings has a Reynolds number of 6,000 to 8,000.

58. The cooling assembly of any of claims 39-57 and 59, further comprising an interdigitated manifold, the interdigitated manifold directing cooling gas to the first plurality of elongate openings and away from the second plurality of elongate openings.

59. The cooling assembly of any of claims 39-58, wherein the slots are arranged such that their long dimension is oriented substantially perpendicular to the direction of travel of parts beneath the cooling assembly.

60. A method of cooling an article being printed using a selective toner electrophotographic printing system, the assembly comprising, the method comprising:
providing a substantially planar surface for delivering and returning cooling gas, the surface oriented parallel to the path of travel of the article being printed and containing:
a first plurality of elongate openings having a width of less than 2 millimeters, the first plurality of elongate openings in communication with a cooling gas supply; and
a second plurality elongate openings having a width of less than 2 millimeters, the second plurality of elongate openings in communication with a cooling gas return;
wherein the length and width of the first plurality of elongate openings are substantially the same as the length and width of the second plurality of elongate openings; the first plurality of elongate openings and second plurality of elongate openings are substantially parallel to one another and alternate with one another; and
passing an article being printed beneath the substantially planer surface a distance of approximately 30 to 70 percent of the width of the first plurality of elongate openings.

61. The method of any of claims 60 and 62-81, wherein the cooling gas is supplied at a pressure of less than 50 kilopascals.

62. The method of any of claims 60-61 and 63-81, wherein the cooling gas is supplied at a pressure of less than 25 kilopascals.

63. The method of any of claims 60-62 and 64-81, wherein the cooling gas is supplied at a pressure of less than 10 kilopascals.

64. The method of any of claims 60-63 and 65-81, wherein the cooling gas is supplied at a pressure of less than 5 kilopascals.

65. The method of any of claims 60-64 and 66-81, wherein the cooling gas is supplied at a pressure of less than 3 kilopascals.

66. The method of any of claims 60-65 and 67-81, wherein the surface for delivering and returning cooling gas is oriented above an article during printing of the article.

67. The method of any of claims 60-66 and 68-81, wherein the surface containing the first plurality of elongate openings and second plurality of elongate openings are configured to be positioned parallel to a build platform in the selective toner electrophotographic printing system.

68. The method of any of claims 60-67 and 69-81, wherein the surface is maintained above the article being printed by a distance of approximately 45 to 55 percent of the width of the first plurality of elongate openings.

69. The method of any of claims 60-68 and 70-81, wherein the surface is maintained above the article being printed by a distance of approximately 40 to 60 percent of the width of the first plurality of elongate openings.

70. The method of any of claims 60-69 and 71-81, wherein the surface is maintained above the article being printed by a distance of less than 2 millimeters above an article being printed.

71. The method of any of claims 60-70 and 72-81, wherein the surface is maintained above the article being printed by a distance of less than 1 millimeters above an article being printed.

72. The method of any of claims 60-71 and 73-81, wherein the first and second plurality of openings have a width of less than 3 millimeters.

73. The method of any of claims 60-72 and 74-81, wherein the first and second plurality of openings have a width of less than 1 millimeter.

74. The method of any of claims 60-73 and 75-81, wherein the first and second plurality of openings are spaced from one another by less than 30 millimeters.

75. The method of any of claims 60-74 and 76-81, wherein the first and second plurality of openings are spaced from one another by less than 20 millimeters.

76. The method of any of claims 60-75 and 77-81, wherein the first and second plurality of openings are spaced from one another by a distance of approximately 2 to 30 times the width of the plurality of openings.

77. The method of any of claims 60-76 and 78-81, wherein the first and second plurality of openings are spaced from one another by a distance of approximately 5 to 20 times the width of the plurality of openings.

78. The method of any of claims 60-77 and 79-81, wherein the first and second plurality of openings are spaced from one another by a distance of approximately 10 to 20 times the width of the plurality of openings.

79. The method of any of claims 60-78 and 80-81, wherein the cooling gas flowing from the first plurality of openings to the second plurality of openings has a Reynolds number of less than 10,000.

80. The method of any of claims 60-79 and 81, further comprising an interdigitated manifold, the interdigitated manifold directing cooling gas to the first plurality of elongate openings and away from the second plurality of elongate openings.

81. The method of any of claims 60-80, wherein the slots are arranged such that their long dimension is oriented substantially perpendicular to the direction of travel of parts beneath the cooling assembly.
